(19) United States
(12) Patent Application Publication
(10) Pub. No.: US 2007/0148280 A1
(43) Pub. Date: Jun. 28, 2007

(54) Mold cavity structure

(76) Inventors: Marek Hönisch, Hunstetten (DE); Christian Wagner, Mainz (DE); Klaus Wegmann, Ingelheim (DE)

Correspondence Address: SIMPSON & SIMPSON, PLLC, 5555 MAIN STREET, WILLIAMSVILLE, NY, 14221-5406, US

(21) Appl. No.: 10/579,993

(22) PCT Filed: Nov. 5, 2004
(86) PCT No.: PCT/EP04/52837

§ 371 Date: Feb. 8, 2007

(30) Foreign Application Priority Data
Nov. 25, 2003 (DE) 103 55 018.6

(51) Int. Cl. B29C 45/00

(52) U.S. Cl. 425/577

(57) ABSTRACT

A mold for the production of hollow moldings, wherein the mold has a mold space (5), within a cavity (1) having an inner contour corresponding at least in sections to an outer contour of a molding to be produced and the mold has a core (2)within the cavity, the outer contour of which corresponds at least in sections to an inner contour of the molding to be produced, and a supporting ring (3) which at least partially surrounds the core (2) when the mold cavity is closed, wherein the supporting ring (3) has an inner cone (9) and the core (2) a corresponding outer cone (8), which are formed such that at least when the mold cavity is closed, the inner cone (9) of the supporting ring (3) comes into contact with the outer cone (8) of the core (2), wherein neither the inner cone (9) of the supporting ring (3) nor the outer cone (8) of the core (2) directly adjoins the mold space (5). The invention also includes a core and supporting ring for use with the mold.

### BACKGROUND OF THE INVENTION

The present invention relates to a mold cavity for housing in a melding tool for the production of hollow molding by means of injection molding.

In plastics processing, injection molding represents the most important process for the production of molding. The essence of the process is that the intermolecular forces which hold together the linear or branched chains of the macromolecules of which the plastic consists become weaker upon exposure to heat, so that the plastic can then be shaped. With injection-molding machines, molding from the gram to the kilogram range can be produced. Plastics which are machined using the injection-molding process are generally thermoplastics, although the processing of thermosets and elastomers is also possible. In injection molding the powdery or granulated molding compound is plasticized, e.g. in a screw injection-molding machine, and then forced e.g. by axial displacement of the screw through the injection channel into the closed generally cooled tool, e.g. a mold cavity.

If the mold or the mold space provided therein is completely filled by the melt, this solidifies through cooling. In general there is a reduction in volume. This is frequently compensated by renewed forcing of melt from the injection cylinder into the mold. In general, account is additionally taken of the shrinkage by a corresponding oversizing in the mold contour. Finally, the tool or the mold cavity is opened and the finished molding (injection-molded article) demolded and ejected. The tool can be closed again and a new working cycle can begin with the renewed injection.

Using injection molding it is possible to produce hollow items which can be blown up in a later production step, e.g. to form bottles or canisters. These hollow items are also called preforms.

A known mold cavity is shown in FIGS. 1 to 3. FIGS. 1a and 1b show two sectional views of a mold cavity when closed. The mold cavity forms a mold space 5 into which the plasticized plastic is introduced. Here, the mold space 5 has the shape of a preform with thread 7 and neck or carrier ring 6. The inner contour of the mold space 5 is formed by the core 2, more accurately by its outer contour. Here a cooling pipe 12 through which coolant can be conducted through the core is let into the core 2. The core 2, which is also represented on its own in FIG. 2 in a side view, has a journal 14 with which the core 2 can be attached to a reception plate (not represented). The outer contour of the mold space 5 is thus determined in the present case by four elements, namely the neck follower 4, the cavity 1, the supporting ring 3 and the base insert 13. However, it is understood that this four-way split is not absolutely necessary and the outer contour of the molded article could also be determined by fewer or more elements. To produce the preform, the plastic compound is plasticized in a plasticizing device (not shown) and homogenized and introduced into the mold space 5 through the base insert 13.

The cavity 1 has cooling channels 17 through which a coolant can be conducted in order to be able to cool the cavity swiftly. The mold space 5 is thus formed from the core 2 and the elements surrounding the core at a small distance from same, namely the neck follower 4, the cavity 1 and the base insert 13 and also the supporting ring 3. However, as the core 2 generally has a considerable longitudinal extent, it is necessary to centre this during operation and if possible to support it. In the shown embodiment the supporting ring 3 which surrounds the core 2 and comes into contact with same at a non-chamber-forming section, assumes this function. For this purpose the core 2 has an outer cone 8 and the supporting ring 3, which is once again represented separately in FIG. 3, once again in a sectional view, has a corresponding inner cone 9. The outer cone of the core 2 is constructed such that the core 2 tapers in the direction of the section forming the mold space 5. The result of this is that the core 2 and the neck follower 4 is centered above the supporting ring 3. In addition, the clamping force of the clamping unit is transmitted by the supporting ring 3 onto the neck follower 4, generally designed in two parts. The clamping force of the clamping unit prevents the tool from opening under the action of the high injection pressure. The clamping force exerted on the core is transmitted by the inner cone of the supporting ring 3 via the outer cone of the neck follower 4 so that the neck follower 4 is prevented from opening due to the high injection pressure.

In the embodiment shown here the neck follower 4 has a further outer cone facing the cavity 1 and the cavity 1 has an inner cone facing the neck follower 4, so that these two parts also come into contact via their correspondingly matched cones. Here, therefore, the clamping force is also transmitted from the cavity plate (not shown) in which the cavity 1 is received, via the correspondingly matched cones, onto the neck follower 4.

Furthermore a feed channel is provided for blow-out air. The feed channel runs, as can be seen in FIGS. 1a and 1b, from the reception plate (not shown) in which the core 2 is received, firstly through a connecting bore 11 in the supporting ring 3. This connecting bore 11 extends as far as a first section 18 of the supporting ring 3 with enlarged inner diameter so that the air received by the connecting bore 11 into the supporting ring 3 can enter the cavity formed by the supporting ring 3. The blow-out air is then fed further via an annulus 10 which surrounds the core 2 at least in sections. This annulus 10 ends in a second section 19 with enlarged inner diameter of the supporting ring 3. From there, feed channels 24 run which can be seen in FIG. 1b, as far as the contact surface between supporting ring 3 on one side and neck follower 4 on the other side.

In the closed state shown in FIGS. 1a and 1b of the mold cavity the plasticized plastic can be introduced into the mold space 5. After a suitably chosen cooling time the supporting ring 3 is then moved together with the core 2 and the neck follower 4 which are connected to the reception plate (not shown), in the direction of the reception side 15, while the cavity 1 including the base insert 13 which is connected to the plasticizing unit (not shown) is moved in the direction of the connection side 16. It may be stressed at this point that the described movements are relative movements. It is thus for example also possible, as is frequently the case, not to move the so-called hot side, i.e. the cavity 1 including the base insert 13, and move core 2 and supporting ring 3 as well as neck follower 4 away from the hot side.

In the next step the generally two-part neck follower 4 can be removed from the neck region of the preform so that the finished preform can be removed.

However, in the shown embodiment slight flashing may occur in the contact region between the neck follower 4 and the cavity 1, something which in many cases, e.g. when using the molding in the field of cosmetics, is undesired. There are therefore already embodiments in which this flash, i.e. the connection point between neck follower 4 and cavity 1, has been moved to a less disruptive position, i.e. to the vicinity of the neck or supporting ring 6. Such an embodiment is shown in FIG. 4a. It can be clearly seen that here the cavity 1 extends much further in the direction of the neck or carrier ring 6 so that the separating line between cavity 1 and neck follower 4 also lies closer against the neck or carrier ring 6.

This measure alone would however lead to a substantial reduction of the neck follower 4 in longitudinal direction, which would no longer be manageable in design terms. Therefore in this embodiment the side of the neck follower which faces the reception side 15 has been reconfigured. Here, on its side facing the reception plate (not shown) (left in the diagram), the neck follower 4 has an inner cone which comes into contact with a cone element 20 screwed to the core. However, this cone element 20 merely fulfills a centering function of the core. The clamping force is no longer transmitted from the reception side onto the neck follower 4, as the outer cone of the cone element 20 cannot prevent an opening of the neck follower 4, but on the contrary under certain circumstances actually transmits an opening force onto the neck follower. For this reason, in some embodiments the outer cone of the cone element 20 is designed slightly smaller than the inner cone of the neck follower 4, in order to prevent the application of an opening force by the cone element 20. The clamping force must thus be made available exclusively via the cavity 1.

In this embodiment, the blow-out air is fed in other ways. Here the blow-out air 10 is transmitted through oblong bores 21 (producible only at great cost) in the core 2 as far as the fitted cone element 20, which in turn has bores 24 (shown in FIG. 4b which represent another sectional view), which connects the blow-out air channel 21 to the parting surface between the neck follower 4 and the fitted cone element 20.

The embodiments shown in FIGS. 1 to 4 have the disadvantage that changing between the two embodiments requires the core 2 to be replaced. The embodiment according to FIGS. 4a and 4b is costly to produce. The core 2 which must house the blow-out air channel 21 must be produced with much greater wall thickness compared with the embodiment according to FIG. 1. As the whole core is worked from solid metal this means, however, that when machining the chamber-forming outer contour of the core more material must be removed, which increases machine time and leads to an increased stress on the machine. Moreover, the bores for forming the blow-out air channel 21 are costly to produce.

### BRIEF DESCRIPTION OF THE DRAWINGS

The nature and mode of operation of the present invention will now be more fully described in the following detailed description of the invention taken with the accompanying drawing figures, in which:

FIGS. 1a and 1b sectional drawings of a first embodiment of the mould mold cavity of the state of the art,

FIG. 2 a sectional drawing of a core of a mould mold cavity of the state of the art,

FIG. 3 a sectional drawing of a supporting ring of a mould mold cavity of the state of the art,

FIGS. 4a and 4b two sectional drawings of a second embodiment of a mould mold cavity of the state of the art,

FIG. 5 a sectional drawing of a first embodiment of a mould mold cavity according to the invention,

FIG. 6 a part-sectional view of the mould mold cavity of FIG. 5,

FIG. 7 a sectional view from the core from the embodiment shown in FIG. 5,

FIG. 8 a sectional view of the supporting ring of the mould mold cavity shown in FIG. 5,

FIG. 9 a second sectional view of the supporting ring shown in FIG. 8,

FIG. 10 a sectional view of a second embodiment of the mould mold cavity according to the invention,

FIG. 11 a sectional view of the core of the embodiment of a mould mold cavity according to the invention shown in FIG. 10,

FIG. 12 a sectional view of the supporting ring of the second embodiment shown in FIG. 10 of the mould mold cavity according to the invention and

FIG. 13 a second sectional view of the supporting ring of FIG. 12.

### BRIEF DESCRIPTION OF THE INVENTION

Against the background of the described state of the art, the object of the invention is therefore to provide a mold cavity or a core and a supporting ring which may be easily matched to different molding and which is easy to produce.

This object is achieved by a mold cavity for housing in a molding tool, wherein the mold cavity forms a mold space and has a cavity whose inner contour corresponds at least in sections to the outer contour of the molding to be produced, a core which enters the cavity when the cavity is closed and whose outer contour corresponds at least in sections of the inner contour of the molding to be produced, and a supporting ring which at least partially surrounds the core when the mold cavity is closed, wherein the supporting ring has an inner cone and the core a corresponding outer cone which are formed such that at least when the mold cavity is closed, the inner cone of the supporting ring comes into contact with the outer cone of the core, wherein neither the inner cone of the supporting ring nor the outer cone of the core is connected to the mold space. In other words, in axial direction neither the inner cone of the supporting ring nor the outer cone of the core directly joins onto the mold space.

Advantageously, core and supporting ring are each formed such that a cylindrical section lies between the chamber-forming section, i.e. the section which forms one wall of the mold space or where outer and inner contour corresponds respectively to the inner and outer contour of the molding, and the outer or inner cone, wherein the cylindrical sections of core and supporting ring come into contact with one another when the mold cavity is closed. The cylindrical sections advantageously ensure a centering of the core.

An embodiment in which the inner cone of the supporting ring is provided substantially on the side of the supporting ring facing away from the cavity is particularly preferred.

Furthermore, in a particularly preferred embodiment, a neck follower is provided whose inner contour corresponds at least in sections to the outer contour of the neck region of the molding moldings to be produced. Because the outer delimitation of the mold space is formed by more than on part, i.e. by the cavity and the neck follower the molding process, i.e. the removal of the finished molding from the tool, is made easier.

Furthermore, in a preferred embodiment a feed channel for blow-out air is provided. The removal of the molding is also made easier by the blow-out air. Thus the molding can be blown away from the core by the blow-out air. The removal of the molding can thereby take place more reliably and quickly, whereby the opening time can be reduced.

In a particularly preferred embodiment the feed channel for blow-out air is realized at least in sections by an annulus formed between core and supporting ring. The advantage of forming the feed channel for blow-out air as an annulus between core and supporting ring is that this can be produced easily and therefore at favourable cost. For this, it is merely necessary to choose an inner diameter of the supporting ring that is somewhat larger than the outer diameter of the core. An annulus, through which the blow-out air can be conducted, thus automatically results between core and supporting ring.

It is understood that this annulus cannot extend into the area of the connected cones. Therefore in a particularly preferred embodiment the feed channel for blow-out air is realized at least in the area of the inner cone of the supporting ring by a bore, preferably running substantially in longitudinal direction of the supporting ring, in the supporting ring. As the longitudinal extent of the cone of the supporting ring generally occupies only a fraction of the longitudinal extent of the supporting ring, the bore must likewise cover only this short area.

As the supporting ring also extends as far as the mold space, the annulus can also not be formed extending as far as the neck follower, as the annulus would then be connected to the mold space and plasticized plastic would also enter the annulus. Therefore it is provided in a particularly preferred embodiment that the feed channel for blow-out air is realized at least in sections by a bore running in the supporting ring, wherein this bore is preferably arranged such that when the molding tool is closed it ends at the contact surface of supporting ring and neck follower.

Regarding the core, the above-named object is achieved by the core having an outer cone which does not join directly onto the chamber-forming section of the core. This outer cone is provided to come into contact with a corresponding inner cone of the supporting ring, so that the supporting ring ensures that the core is centered and held.

The core preferably has a side forming the mold space and a connection side for housing the core on or against a reception plate. The outer cone is particularly preferably arranged substantially in the area of the connection side.

In order to provide a feed channel for the blow-out air, in a particularly preferred embodiment the core has a section between the outer cone and the section forming the mold space whose outer diameter is reduced compared with the section with outer cone and compared with the section forming the mold space.

Regarding the supporting ring, the object named at the outset is achieved by the supporting ring having an inner cone which is not directly connected to the chamber-forming section of the supporting ring. The inner cone is, rather, provided to engage with a corresponding outer cone of the core in order to centre and hold the core.

The supporting ring preferably has a reception side for the engagement with a reception plate and a cavity side for the engagement with the neck follower or the cavity. Particularly preferably the inner cone is arranged substantially in the area of the reception side.

In order to provide a feed channel for blow-out air, in a particularly preferred embodiment a bore running substantially in longitudinal direction is provided at least in the section of the supporting ring having the inner cone.

### DETAILED DESCRIPTION OF THE INVENTION

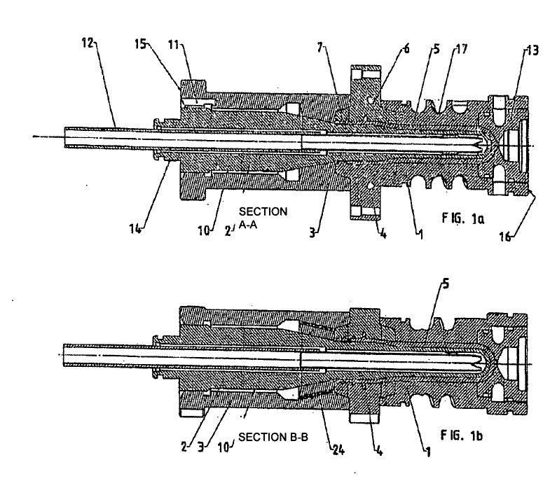

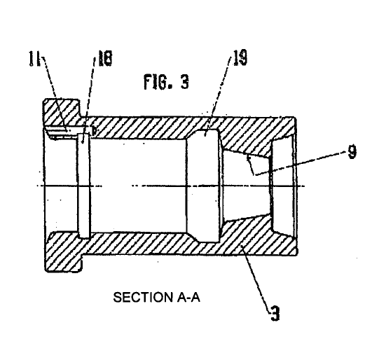

Two embodiments of mold cavities of the state of the art which have already been described in detail above are shown in FIGS. 1 to 4.

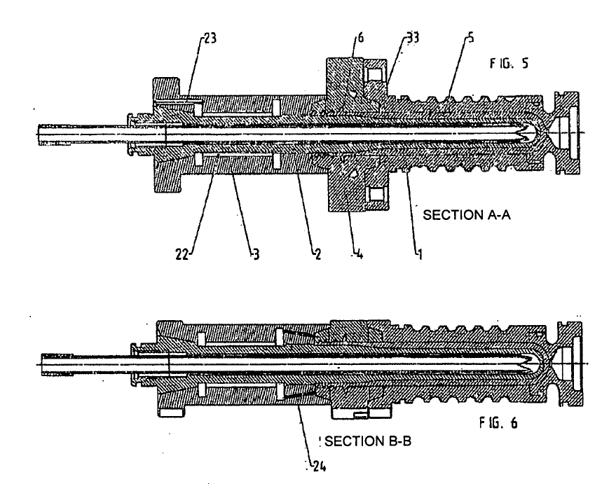

Sectional views of a first embodiment of the mold cavity according to the invention or parts thereof are represented in FIGS. 5 to 9. FIG. 5 shows a sectional view of the complete mold cavity which, similarly to the embodiment shown in FIG. 1, consists of a cavity 1, a neck follower 4, a core 2 and a supporting ring 3. Here also the mold space 5 is formed by the core 2, the neck follower 4, the supporting ring 3 and the cavity 1. The neck follower 4 grips round the upper part of the mold space 5 and serves to form the thread and neck area of the molding. The mold space 5 is formed by the distance between the core 2 and the neck follower 4 and the cavity 1. In other words the core 2 touches neither the neck follower 4 nor the cavity 1. The supporting ring 3 forms the upper edge of the thread or of the neck region of the molding.

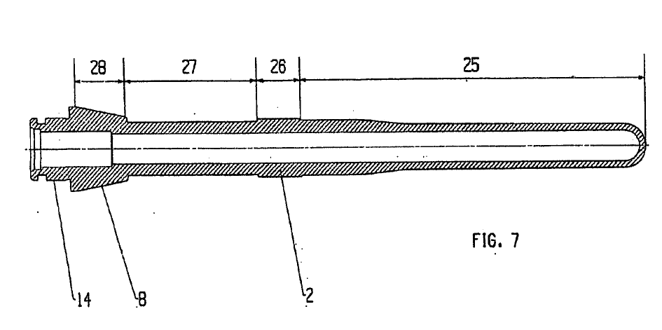

The core 2, also represented separately in FIG. 7 in a sectional view, has at its foot a journal 14 which is provided for the connection of the core to the reception plate (not shown). The core 2 has a core tip, the outer contour of which corresponds substantially to the inner contour of the molding to be produced. This section has the reference number 25 in FIG. 7. Directly joined onto the section 26 is a section 25 which forms the mold space 5, the outer diameter of which is somewhat enlarged compared with the outer diameters of the section 25. This section 26, which is not designed conical, serves to come into contact with the supporting ring 3. Joined onto the section 26 is a further section 27, the outer diameter of which is somewhat reduced compared with the outer diameter of the section 26. As is described further below, this section 27 serves to provide an annulus 22 between core 2 on one side and supporting ring 3 on the other side for the feeding of blow-out air.

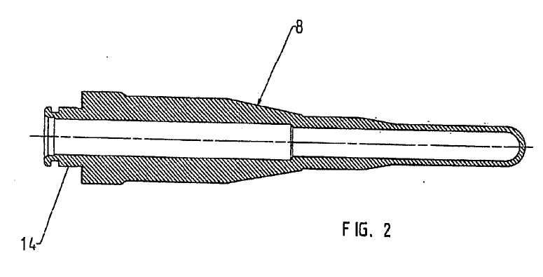

Section 28, which is designed conical, then joins onto section 27, wherein its outer diameter increases in the direction of the foot of the core to which the journal 14 is attached. Section 28 thus forms the outer cone 8 of the core 2. Compared with FIG. 2 it is noticeable that here, according to the invention, the outer cone 8 has been shifted away from the tip of the core, substantially into the foot of the core 2. Unlike the embodiment shown in FIGS. 1 to 3, in the embodiment according to the invention the conical section 28 now no longer ends directly next to the chamber-forming section 25, as a consequence of which it is not connected to same and therefore the conical section 28 can preserve its design, if a molded article with other contours is to be produced with the same tool. It is therefore possible, without knowing the precise design of the molded article, to already produce several cores with identical outer cones. The matching to the actual geometry of the preform can then take place, wherein then only still the outer contour of the core still has to be machined, but the already pre-produced outer cone can remain unchanged. This reduces the production costs of the mold cavity.

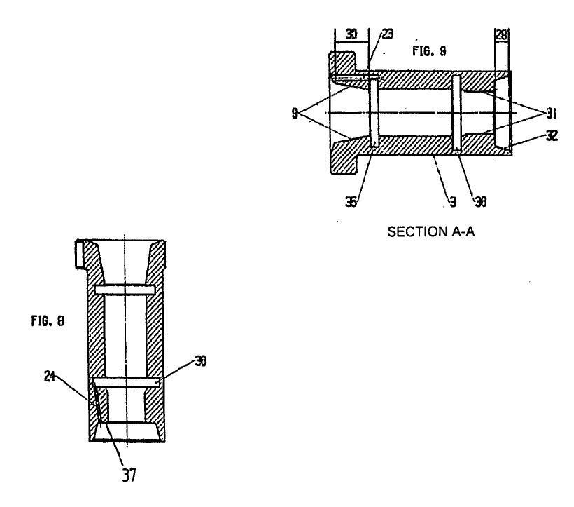

Two cross-sectional drawings of the supporting ring 3 according to the invention are represented in FIGS. 8 and 9. In its foot area 30, this supporting ring 3 has an inner cone 9 which is formed such that the inner diameter of the substantially cylindrical supporting ring 3 widens in the direction of the foot of the supporting ring. The inner cone 9 is matched to the outer cone 8 of the core 2 such that, as can be seen in FIG. 5, in the connected state, the inner cone 9 of the supporting ring 3 lies on the outer cone 8 of the core 2 and the core 2 and the supporting ring 3 thereby exert a clamping force on the supporting ring 3. In the front section of the supporting ring according to the invention shown in FIG. 8 the supporting ring has a non-conical inner surface 31 which is matched such that it engages with the section 26 of the core 2. The connection between the non-conical surface 31 of the supporting ring 3 on the one hand and the non-conical surface 26 of the core 2 on the other makes available a centering function, as the core 2 is centered in the supporting ring 3 on the basis of the named contacting.

In the front area 29 of the supporting ring 3 the supporting ring has an inner cone 32 which is formed such that its inner diameter decreases in the direction of the foot of the supporting ring.

As is seen in FIG. 5, this conical section is provided to engage with a corresponding conical section of the neck follower 4.

At its foot-end in the area of the section 30 with inner cone 9 the supporting ring 3 has a channel 23 designed as a bore. This channel 23 extends from the foot as far as a section 35 of the supporting ring 3 with widened inner diameter. As can be seen in FIG. 5, in the connected state an annulus 22 is formed between the section 27 of the core 2 and the supporting ring 3, i.e. in this area the core 2 does not touch the supporting ring 3. The channel 23 serves, together with the section 35 with widened inner diameter of the supporting ring 3, to connect the foot of the supporting ring to the annulus 22 for the passing-through of blow-out air. It is thereby guaranteed that, although the supporting ring 3 is in contact with the core 2 via the inner or outer cone 8, 9, blow-out air can be conducted past this contact surface into the annulus 22. In the area of its tip the supporting ring 3 has a further section 36 with widened inner diameter. Furthermore a channel 24 is provided near the section 29 of the supporting ring 3. The channel 24 can be seen in FIG. 9, which represents a different sectional view of the supporting ring from FIG. 8. In other words, the channel 23 and the channel 24 are not arranged in the same sectional plane. The channel 24 connects the section 36 with widened inner diameter to the end-surface 37, i.e. the surface of the supporting ring 3 which faces away from the foot. It can be seen in FIG. 6 that the channel 24 ends at the contact surface between supporting ring 3 and neck follower 4. Because of the described channel and annulus design it is therefore possible to pass blow-out air from the reception plate (not shown) as far as the neck follower 4 through the supporting ring or along the core without the contact surfaces between the conical sections of the supporting ring and the core and the non-conical contact surfaces having to be interrupted.

In the embodiment shown in FIG. 5 during the production of the molding an easily visible mold-parting line 33 forms at the connection point between neck follower 4 and cavity 1.

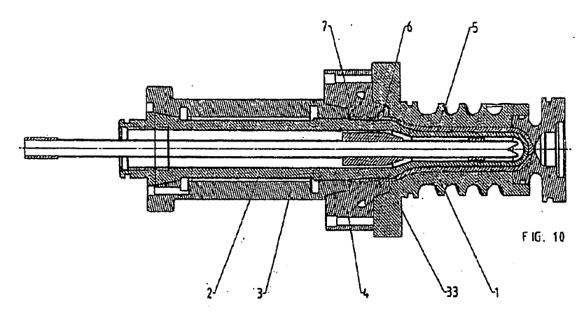

Therefore a second embodiment of the present invention is shown in FIG. 10 in which the mold-parting line 33 has been shifted further in the direction of the neck or carrier ring 6, compared with the embodiment shown in FIG. 5.

This shifting of the parting line 33 leads to a reduction in the thickness of the neck follower 4 in the direction of the cavity 1. As, for reasons of static, the neck follower 4 cannot be of just any chosen thickness, the shifting of the parting line requires a redesign of the connection between neck follower 4 and supporting ring 3. It can be seen in FIG. 10 that, on its side facing the supporting ring 3, the neck follower 4 now has an inner cone instead of an outer cone, which engages with an outer cone of the supporting ring 3.

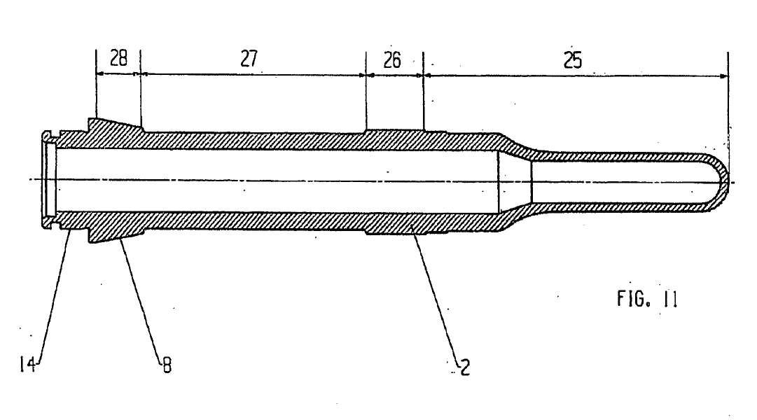

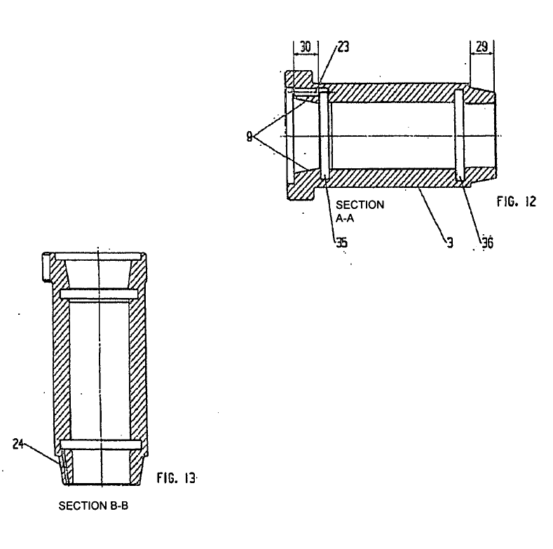

A sectional view of the core 2 of the embodiment shown in FIG. 10 is represented in FIG. 11. It is clearly seen that the core 2 of the embodiment of FIG. 10 can be identical to the core of the embodiment of FIG. 5 so that, when modifying the machine in the event of a change of molded article to be produced, where necessary the core does not have to be replaced. Two different sectional views of the supporting ring of the embodiment shown in FIG. 10 are shown in FIGS. 12 and 13.

It is clearly seen that the supporting ring 3 in the embodiment shown in FIGS. 10 to 13 differs from the supporting ring 3 of the embodiment shown in FIGS. 5 to 9 merely at the connection area between supporting ring 3 and neck follower 4.

Here, provided in the front area 29 of the supporting ring 3, is an outer cone 32 which is formed such that its outer diameter widens in the direction of the foot of the supporting ring.

As can be seen in FIG. 10, this conical section is provided to engage with a corresponding conical section of the cavity 1.

Reference is therefore made to the previous description for a description of the details.

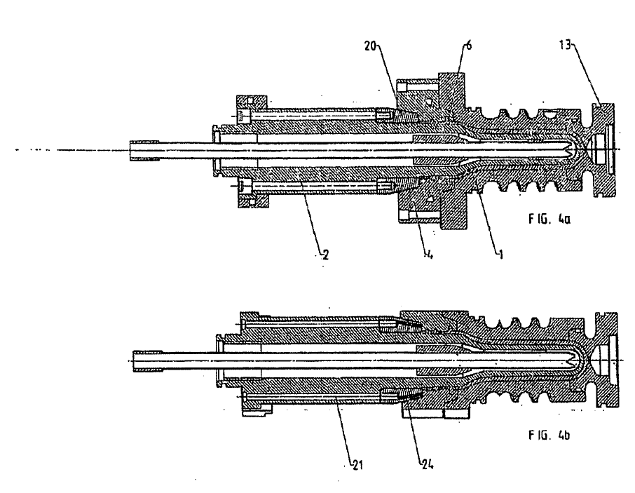

By comparing the embodiment according to the invention as per FIG. 13 with the embodiment of the state of the art as per FIG. 4 it becomes clear that in particular the guiding of the blow-out air can clearly be realized more simply and thus at considerably less cost.

### List of Reference Numbers

1 cavity
2 core
3 supporting ring
4 neck follower
5 mold space
6 neck or carrier ring
7 thread
8 outer cone
9 inner cone
10 annulus
11 connecting bore
12 cooling pipe
13 base insert
14 journal
15 connection side of the supporting ring
16 connection side of the cavity
17 cooling channels
18 first section with widened inner diameter
19 second section with widened inner diameter
20 cone element
21 oblong bore of the blow-out air channel
22 annulus
23 bore, channel
24 feed channel for air
25 chamber-forming core section
26 core section with enlarged outer diameter
27 section
28 section with outer cone
29 cone area
30 foot area
31 surface
32 inner cone
33 mold-parting line
35 section
36 section
37 end-surface of the supporting ring

What we claim is:

1. A mold for the production of hollow moldings, wherein the mold has a mold space (5), within a cavity (1) having an inner contour corresponding at least in sections to an outer contour of a molding to be produced and the mold has a core (2) within the cavity, the outer contour of which corresponds at least in sections to an inner contour of the molding to be produced, and a supporting ring (3) which at least partially surrounds the core (2) when the mold cavity is closed, wherein the supporting ring (3) has an inner cone (9) and the core (2) a corresponding outer cone (8), which are formed such that at least when the mold cavity is closed, the inner cone (9) of the supporting ring (3) comes into contact with the outer cone (8) of the core (2), wherein neither the inner cone (9) of the supporting ring (3) nor the outer cone (8) of the core (2) directly adjoins the mold space (5).

2. A mold according to claim 1 wherein the core (2) between the section corresponding to the inner contour of the molding to be produced and the outer cone has a section with a cylindrical outer contour and the supporting ring (3) has a section with a cylindrical inner contour, which is in contact, at least when the molding tool is closed, with the section with the cylindrical outer contour of the core (2).

3. A mold cavity according to claim 1 wherein the inner cone (9) of the supporting ring (3) is provided substantially at a side of the supporting ring (3) facing away from the cavity (1).

4. A mold according to claim 1 wherein a neck follower (4) is provided whose inner contour corresponds at least in sections to the outer contour of the neck region of the molding to be produced.

5. A mold according to claim 1 wherein a feed channel is provided for blow-out air.

6. A mold according to claim 5 wherein the feed channel for blow-out air is realized at least in sections by an annulus (22) formed between core (2) and supporting ring (3).

7. A mold according to claim 5 wherein the feed channel for blow-out air is realized at least in the area of the inner cone (9) of the supporting ring (3) by a bore (23) preferably running substantially in longitudinal direction of the supporting ring in the supporting ring (3).

8. A mold according to claim 5 wherein the feed channel for blow-out air is realized at least in sections by a bore (24) running in the supporting ring (3).

9. A core for a mold according to claim 1 with a section which is provided for the formation of the mold space wherein the core (2) has an outer cone (8), wherein the outer cone is neither attached to the mold-space-forming section nor directly joined onto it.

10. A core according to claim 9 wherein between the section corresponding to the inner contour of the molding to be produced and the outer cone (8) the core (2) has a section with cylindrical outer contour.

11. A core according to claim 9 wherein the core (2) has a side forming the mold space (5) and a connection side for housing the core (2) against or in a reception plate.

12. A core according to claim 11 wherein the outer cone (8) is arranged substantially in the area of the connection side.

13. A core according to claim 11 wherein the core (2) has a section (27) between the outer cone (8) and the section (25) forming the mold space (5) whose outer diameter is reduced compared with the section with the outer cone.

14. A supporting ring for a mold cavity according to claim 1 with a section which is provided for the formation of the mold space (5), characterized in that the supporting ring (3) has an inner cone (9), wherein the inner cone (9) is not attached to the mold-space-forming section and does not directly join onto it.

15. A supporting ring according to claim 14 wherein the supporting ring (3) has a reception side for the engagement with a reception plate and a cavity side for the engagement with the cavity or the neck follower (4).

16. A supporting ring according to claim 14 wherein a section (31) with cylindrical inner contour is provided between inner cone (9) and the cavity.

17. A supporting ring according to claim 14 where the inner cone (9) is arranged substantially in the area of a reception side.

18. A supporting ring according to claim 14 wherein a connecting bore (23) running substantially in a longitudinal direction is provided for receiving blow-out air at least in a section (30) having the inner cone (9).

19. A supporting ring according to claim 18 wherein a feed channel (24) for blow-out air is provided substantially in a section with a cylindrical inner contour (31).

20. A mold according to claim 8 wherein the bore (24 is arranged such that when the mold is closed the bore ends at the contact surface of supporting ring (3) and neck follower (4).

21. A core according to claim 13 wherein the core (2) has a section (27) between the outer cone (8) and the section (25) forming the mold space (5) whose outer diameter is reduced compared with a cylindrical section (26) arranged between the outer cone and section 25 forming mold space (5).
